(19) United States
(12) Patent Application Publication
(10) Pub. No.: US 2017/0349327 A1
(43) Pub. Date: Dec. 7, 2017

(54) MAGNETIC HOLDER

(71) Applicant: Lukasz Stanislaw Cwojdzinski, Brooklyn, NY (US)

(72) Inventor: Lukasz Stanislaw Cwojdzinski, Brooklyn, NY (US)

(21) Appl. No.: 15/175,547

(22) Filed: Jun. 7, 2016

(51) Int. Cl. B65D 23/00; B65D 1/02; F16B 1/00; F16M 13/02; F16B 2/08

(52) U.S. Cl. CPC B65D 23/001; F16M 13/022; F16B 2/08; F16B 1/00; B65D 1/0223; B65D 2313/04; F16B 2001/0028; F16B 2001/0035

(57) ABSTRACT

Embodiments of a magnetic holder that utilizes a magnet to attach a bottle or other object to a ferromagnetic surface are disclosed.

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright Lukas Cwojdzinski 2015, All Rights Reserved.

### TECHNICAL FIELD

The present disclosure relates to a magnetic apparatus which allows an ordinary bottle or other hand held object of almost any size and weight to be adhered magnetically to a ferromagnetic surface.

### BACKGROUND

In countless scenarios, it is necessary to have your hands free, though you require a bottle containing liquids for consumption or some other object, like a towel or bag, to be kept close at hand. For example, when exercising in a gym, utilizing exercise equipment, the most probable place that a person will put their water bottle is on the floor. The problem with putting a bottle on the floor is that it is often times inconvenient to bend over to put it down and pick it up, it may then be obtrusive to yourself and others, and the floor can often subject the bottle to harmful unsanitary conditions.

Several solutions have been created in an effort to solve this problem of how to keep a bottle close at hand while keeping your hands free, including, for example: a pouch with a magnetic attachment, structures that are permanently attached to surfaces, holders that attach to surfaces with other mechanisms but not magnetically. However, these solutions fail to securely hold bottles or other objects of various sizes, and/or lack the ability to attach the bottle or other object to a variety of surfaces and structures. Magnets provide the convenience and ease of use for attaching a bottle or other object to a ferromagnetic surface.

### SUMMARY

In one aspect, the present disclosure provides a magnetic apparatus for attaching a bottle or other object to a ferromagnetic structure. The magnetic apparatus includes a non-ferromagnetic case housing a magnet and slidably receiving a fastening strap. The fastening strap has a hook portion and a loop portion on an anterior surface of the strap and a ring affixed to one end of the strap. When used to attach a bottle or other object to a ferromagnetic structure, the fastening strap is secured around the bottle or object by wrapping it around the circumference of the bottle or object with the strap's posterior surface facing the bottle, inserting the opposite end of the strap through the ring, tightening the strap around the bottle or other object and securing the strap by pressing the hook and loop portions together. The magnetic apparatus being thus secured to the bottle or object, the bottle or object may be affixed to a ferromagnetic structure by the magnetic attraction of the magnet housed in the non-ferromagnetic case.

In another aspect, the present disclosure provides a bottle having a body that incorporates a magnet that may be used to attach the bottle to a ferromagnetic surface. The body of the bottle has a bottom surface and a sidewall. The sidewall has a flattened sidewall surface and an upper sidewall portion that is angled with respect to the flattened sidewall portion. The flattened sidewall portion has a cavity formed therein that houses the magnet.

This summary is provided to introduce a selection of concepts within the scope of the present disclosure and is not intended to identify key or essential features of the claimed subject matter. Further details and other features of the present disclosure will be described hereinafter.

### BRIEF DESCRIPTION OF THE DRAWINGS

For a better understanding of the nature, objects, and processes involved in this disclosure, reference should be made to the detailed description taken in conjunction with the accompanying drawings, in which:

FIG. 1 illustrates an anterior view of one embodiment of a magnetic holder according to the present disclosure;

FIG. 2 illustrates a posterior view of the embodiment shown in FIG. 1;

FIG. 3 illustrates a elevated perspective view of the embodiment shown in FIG. 1 in a fastened state;

FIG. 4 illustrates a perspective view of the embodiment shown in FIGS. 1-3 as used for attaching a bottle to a ferromagnetic structure;

FIGS. 5A-C illustrates a profile view, a cross-sectional view and an anterior view, respectively, of an alternative embodiment of a magnetic bottle holder according to the present disclosure; and

FIG. 6 illustrates a profile view the embodiment shown in FIGS. 5A-C as attached to a ferromagnetic structure.

### DETAILED DESCRIPTION

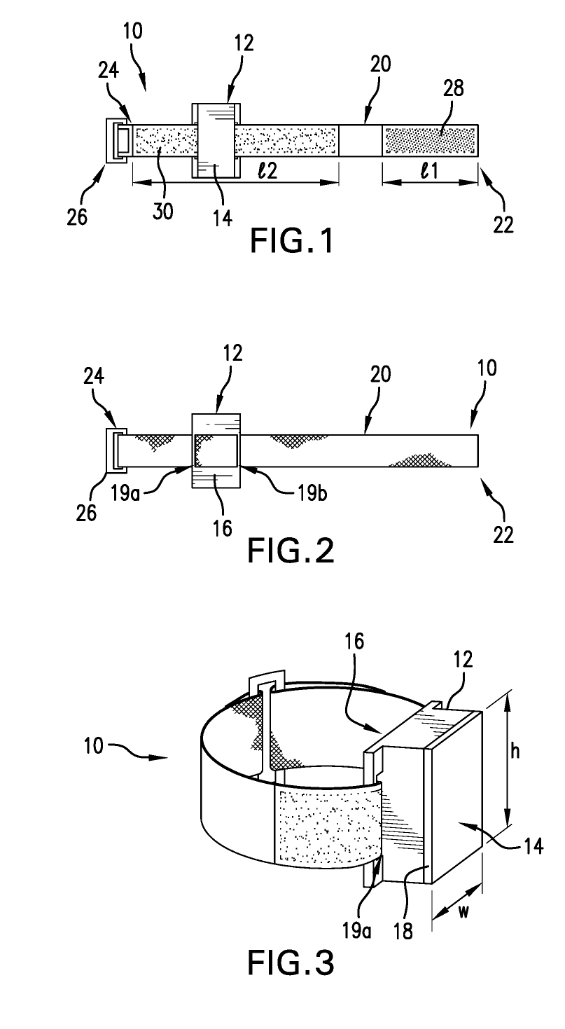

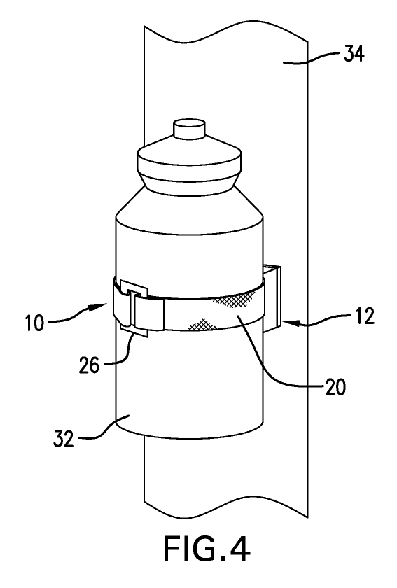

FIGS. 1 and 2 show an anterior view and posterior view, respectively, of one embodiment of a magnetic holder in an unfastened state. FIG. 3 shows an elevated view of the same embodiment in a fastened state. The embodiment 10 shown in FIGS. 1-3 includes a magnet (not shown) held in a non-ferromagnetic case 12 with a fastening strap 20 that is slidably engaged with the case 12. At one end of the fastening strap 20 is affixed a ring 26. This embodiment 10 is secured to a bottle, such as a plastic water bottle, or other hand-held object using the fastening strap and then attached to a ferromagnetic surface, such as a support structure (e.g., table leg, girder, etc.) or piece of gym equipment, using the magnet, as shown in FIG. 4.

The magnet, which may include one or more individual magnets, typically has a (total) strength sufficient to securely attach a bottle, whether empty or full, or other hand-held object, like a towel or bag, to a ferromagnetic structure while also being readily removable using one hand. It has been found that a magnet having a (total) pull force in a range of approximately 15 to 90 pounds, more typically in a range of approximately 30 to 75 pounds, is suitable for use in the magnetic holders of the present disclosure. Each individual magnet may have any shape (e.g., disc, rectangular, bar, cube, etc.), and typically has at least one flat surface.

In the embodiment shown in FIGS. 1-4, the magnet is housed in a non-ferromagnetic case 12 that allows the magnetic field to extend through the case to the ferromagnetic surface to which the bottle is to be attached. The case is sized to abut a side of a typical water bottle and help hold it upright when attached to the ferromagnetic structure, and typically is about 2.5 to about 7.5 cm (about 1 to about 3 inches) high (h) and about 1.2 to about 2.5 cm (about 0.5 to about 1 inch) wide (w). The case is typically made of a plastic, silicone or other polymeric material, though other non-ferromagnetic materials that may be configured to hold the magnet (e.g., neoprene, fabric, etc.) for use according to the present disclosure may be used. The case may be made using known manufacturing methods (e.g., molding, 3D-printing, carving, sewing, etc.).

The case 12 has an anterior side 14 and a posterior side 16. The anterior side and/or the posterior side may include an elastomeric material, such as a natural rubber or synthetic rubber (e.g., neoprene, silicone, polyurethane, etc.), that allows the holder to grip the surface of the ferromagnetic structure and/or the bottle or object, respectively, and protect such surfaces from damage. In the embodiment illustrated, the anterior side 14 is covered with a layer of elastomeric material 18. In other embodiments, the non-ferromagnetic case, or anterior and/or posterior side thereof, may be made of or include an elastomeric material.

The anterior side of the case faces toward the ferromagnetic structure, and the posterior side of the case faces toward the object, when the holder is attached to the object (see FIG. 4 and discussion thereof below). The magnet is typically housed within the case toward the anterior side, to allow the magnet to be close to the ferromagnetic surface and so minimize any interference from the case on the magnet's magnetic field extending to the ferromagnetic surface.

Adjacent the posterior side is a pair of apertures 19a, 19b through which the fastening strap 20 is slidably engaged with the non-ferromagnetic case 12. The pair of apertures 19a, 19b is configured to allow the fastening strap 20 to be engaged with the case and laterally slidable across the case. In the embodiment shown in FIGS. 1-4, the apertures 19a, 19b are longitudinal slits integrally formed with the case, sized to fit and hold flat the fastening strap across the case; however, the apertures may be formed by any means, such as using non-ferromagnetic (e.g., plastic, brass, etc.) rings that are affixed to the posterior side of the case, and have any configuration that allows the fastening strap to laterally, slidably engage with the case.

The fastening strap 20 is used to secure this embodiment to an object (a bottle) 32, as shown in FIG. 4 (discussed further below). The fastening strap may be made of any flexible and durable material, such as plastic, canvas, polyester, polypropylene, nylon, etc., and is typically about 15 to about 61 cm (about 6 to about 24 inches), more typically about 25 to about 45.5 cm (about 10 to about 18 inches), in length. The fastening strap has a first end 22 that is loose and a second end 24 at which is affixed a ring 26. The ring 26 is configured to receive the first (loose) end 22 of the fastening strap so that the fastening strap may encircle the object 32. The ring 26 may take any shape or style (e.g., D-ring, O-ring, rectangular, slide, loop, buckle, etc.) and be made of any durable plastic or non-ferromagnetic metal, such as nylon, anodized aluminum, (austenitic) stainless steel, brass, etc.

The fastening strap has an anterior surface that, when slidably engaged with the case, faces outward in the same direction as the anterior side of the case and a posterior surface that faces outward in the same direction as the posterior side of the case. As shown in FIG. 1, the anterior surface, adjacent to the first (loose) end 22 of the fastening strap, has a hook portion 28, and the anterior surface adjacent to the second end 24 of the fastening strap has a loop portion 30. In other embodiments, the “loop” portion may be adjacent the first (loose) end of the fastening strap and the hook portion adjacent the second end. The terms “hook” and “loop” herein refer broadly to two lineal components that, when pressed together, form a touch fastener that may be separated and reclosed repeatedly, such as Velcro®, Dual Lock™, etc. . . . . The hook and loop portions may be attached or affixed to the fastening strap by any means known, such as adhesive, bonding, sewing, etc.

The hook and loop portions preferably have different lengths so that the fastening strap may be secured in a wide range of circumferences. Typically, the portion adjacent the first (loose) end of the fastening strap has a length (l₁) that is about one-fifth to about one-third the length of the portion adjacent the second end (l₂). For example, the portion adjacent the first end may have a length in a range of about 7.5 to about 12.5 cm (about 3 to about 5 inches), and the portion adjacent the second end may have a length in a range of about 40 to about 47.5 cm (about 12 to about 15 inches). In the embodiment shown in FIG. 1, the hook portion 28 is adjacent the first end 22 and has a length (l₁) of about 9 cm (about 3.5 inches), and the loop portion 30 is adjacent the second end 24 and has a length (l₂) of about 33 cm (about 13 inches). Other embodiments may have the loop portion adjacent the first end and the hook portion adjacent the second end; in such embodiments, the length of the loop portion would be relatively short compared to the length of the hook portion.

The posterior surface of the fastening strap may include an elastomeric material, such as a natural rubber or synthetic rubber (e.g., neoprene, silicone, polyurethane, etc.), that allows the fastening strap to better grip the bottle. The elastomeric material may be coated or otherwise layered on the posterior surface of the fastening strap; alternatively, the fastening strap may be made of, or may incorporate, an elastomeric material. In some embodiments, it may be preferable for the first (loose) end of the strap to not include an elastomeric material, so that it may be more easily inserted through the ring at the second end of the fastening strap.

FIG. 3 shows the embodiment of FIGS. 1-2 in a fastened state, and FIG. 4 shows the same embodiment secured to a bottle 32 and used to attach the bottle to a ferromagnetic structure 34. To attach a bottle (or other object) to a ferromagnetic structure, the fastening strap 20 is secured around the bottle 32 with the posterior surface facing the bottle. In the embodiment 10 shown, the fastening strap is wrapped around the bottle, the first end 22 of the fastening strap is inserted through the ring 26, and the fastening strap 20 tightened by pulling the first end back on the strap and secured around the bottle 32 by pressing the loop portion 30 together with the hook portion 28. When so fastened and secured around the bottle 32, the bottle may be attached to a ferromagnetic structure 34 using the magnet that is housed in the case 12. To detach the bottle 32 from the ferromagnetic structure 34, one need only pull the bottle away from the ferromagnetic structure, with or without tilting the bottle relative to the structure to first break the magnetic attraction.

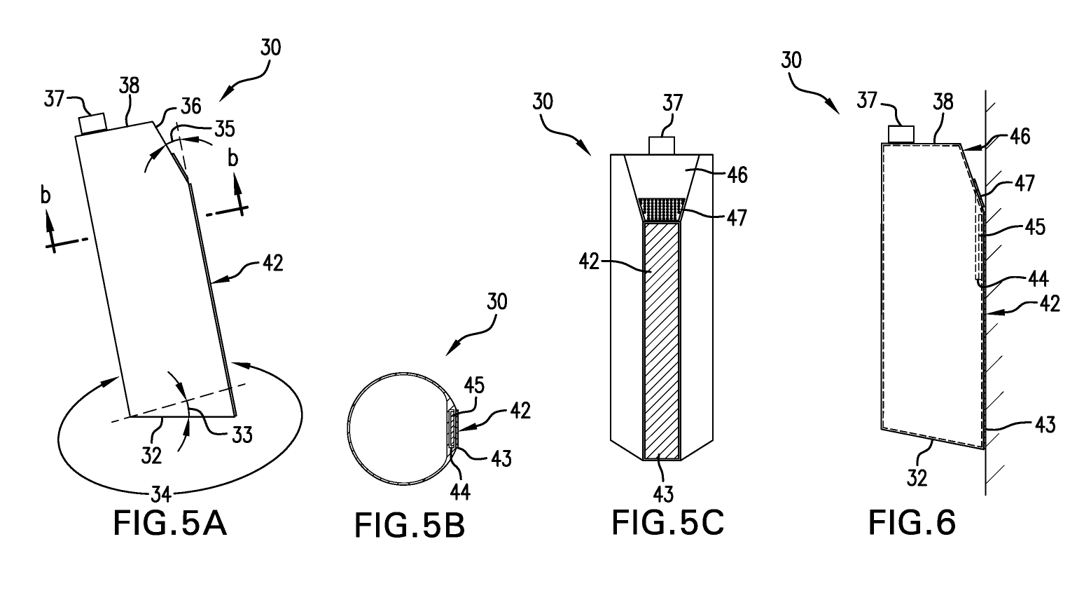

FIGS. 5A-C and 6 show an alternative embodiment of a magnetic bottle holder according to the present disclosure. The embodiment shown incorporates a magnet 45 into a cavity 44 formed into the wall of a bottle body 30 along the interior of a flattened sidewall surface 42. The bottle may be attached flat against a ferromagnetic surface, such as a support structure (e.g., table leg, girder, etc.) or piece of gym equipment, using the magnet, as shown in FIG. 6.

Prior art bottles have a generally right circular cylindrical body shape, with a sidewall that is perpendicular to the bottom surface of the bottle and extends generally straight to the top surface of the bottle. As shown in FIGS. 5A-5C and 6, the bottle embodiment 30 according to the present disclosure has at least one angled surface relative to the sidewall.

In one regard, a bottom surface 32 of the bottle is angled (33) away from being perpendicular with respect to the flattened sidewall surface 42. The angled bottom surface allows the bottle to stand more or less upright while angling the flattened sidewall surface and the magnet housed therein away from vertical. In this way, the bottle is less likely to be inadvertently attached to the ferromagnetic surface when the bottle is put down on its bottom surface. The angle (33) of the bottom surface is typically in a range of about 5 to about 15 degrees.

In another regard, the bottle embodiment has an upper sidewall portion 36 that is angled (35) with respect to the flattened sidewall surface 42. The angled upper sidewall portion 36 intersects with the flattened sidewall surface 42 adjacent to the cavity 44 that houses the magnet 45. The flattened sidewall surface faces toward the ferromagnetic structure to which the bottle attaches and allows the magnet to attach the bottle flat against the ferromagnetic structure. As seen in FIG. 6, the intersection of the flattened sidewall surface 42 and the angled upper sidewall portion 46 forms a pivot that allows for some leverage to be applied to break the magnet's attraction to the ferromagnetic surface and so detach the bottle 30. The angle (35) of the upper sidewall portion is typically in a range of about 15 to about 25 degrees.

The body of the bottle 30 is typically made of a plastic or other polymeric material known in the art to manufacture water bottles, such as a high-density polyethylene (HDPE), a low-density polyethylene (LDPE), a polyester or copolyester (e.g., polyethylene terephthalate (PET)), a polypropylene, and the like. The body of the bottle 30 may be made using known bottle manufacturing methods, such as injection and stretch blow molding, 3D-printing, extrusion, and the like.

In the embodiment shown, the flattened sidewall surface 42 is covered in a layer of an elastomeric material 43, such as a natural rubber or a synthetic rubber (e.g., neoprene, silicone, polyurethane, etc.). The elastomeric layer allows the bottle to grip the surface of the ferromagnetic structure and protects such surfaces from damage. The flattened sidewall surface 42 typically has dimensions that allow the cavity 44 to be configured to house the magnet 45 to be held close to the ferromagnetic surface with minimal interference on the magnet's magnetic field extending to the ferromagnetic surface.

The magnet 45 and the cavity 44 in which the magnet is housed generally have similar strengths and dimensions as the magnet and case of the embodiment shown in FIGS. 1-4. In the embodiment shown in FIGS. 5A-5C and 6, the cavity is formed integrally in the body of the bottle with an opening that is closed with a flap or hinged lid 47 which would allow the magnet to be removed and/or replaced. In other embodiments, the cavity may have an opening that is sealed by a layer of elastomeric material on the flattened sidewall surface. In still other embodiments, the cavity may be integrally sealed, with the magnet not being removable or replaceable.

The bottle embodiment shown 30 has a generally cylindrical shaped body and an opening or spout 37 in a top surface 38 of the bottle from which a liquid may be filled and poured. The bottle body may have the general dimensions and sizes of reusable water/beverage bottles known in the art, and may typically hold a volume of liquid in a range of about 250 mL to about 2000 mL (about 8 to about 64 ounces).

For example, in one specific embodiment, a bottle that holds 64 ounces of liquid may have a circular cross-sectional diameter of about 9 cm (about 3.5 inches). With an angled bottom surface, the length of the bottle sidewalls will vary in height; with the bottom surface angled about 9-degrees from perpendicular, the bottle sidewalls may vary in length in a range of about 26 to about 28 cm (about 10 to about 11 inches). The flattened sidewall surface may have a width of about 2.75 cm (about 1 inch) and a length of about 23 cm (about 10 inches), with the cavity having a width of about 2.75 cm (about 1 inch) and a length of about 5 cm (about 2 inches).

As shown in the profile views of FIGS. 5A and 5C, the bottle embodiment has sidewalls 34 and top and bottom surfaces 38, 32 represented with straight lines. In other embodiments according to the present disclosure, the sidewalls and/or surfaces of the bottle may be curved and/or contoured and/or shaped and/or textured (as known in the art) to be, for example, more comfortably and/or securely grasped and held by one hand and more aesthetically pleasing. FIG. 5B shows a bottle embodiment with a generally circular cross-section; other bottle embodiments according to the present disclosure may have other cross-sectional shapes, such as an oval, square, etc.

It will be understood that the articles “a”, “an”, “the” and “said” are intended to mean that there may be one or more of the elements or steps present. The terms “comprising”, “including” and “having” are intended to be inclusive and mean that there may be additional elements or steps other than those expressly listed.

The foregoing description has been presented for the purpose of illustrating certain aspects of the present disclosure and is not intended to limit the disclosure. Persons skilled in the relevant art will appreciate that many additions, modifications, variations and improvements may be implemented in light of the above teachings and still fall within the scope of the present disclosure.

I claim:

1. A magnetic apparatus for attaching an object to a ferromagnetic structure, the magnetic apparatus comprising:
a magnet;
a fastening strap having a first end and a second end opposite the first end, the fastening strap further having an anterior surface and a posterior surface, the anterior surface having a hook portion adjacent one end of the fastening strap and a loop portion adjacent the other end of the fastening strap;
a non-ferromagnetic case having an anterior side that faces toward the ferromagnetic structure and a posterior side that faces toward the object when the magnetic apparatus is attached to the object, the non-ferromagnetic case being configured to house the magnet toward the anterior side and to slidably receive the fastening strap, wherein the anterior surface of the fastening strap faces in the same direction as the anterior side of the case when the fastening strap is slidably received; and
a ring affixed to the fastening strap at the second end and configured to receive the first end of the fastening strap so that the fastening strap may encircle the object.

2. The magnetic apparatus of claim 1, wherein the magnet has a pull force in a range of about 15 to about 90 pounds.

3. The magnetic apparatus of claim 2, wherein the magnet pull force is in a range of about 30 to about 75 pounds.

4. The magnetic apparatus of claim 1, wherein the non-ferromagnetic case comprises an elastomeric material.

5. The magnetic apparatus of claim 4, wherein the elastomeric material forms a layer that covers the anterior side of the non-ferromagnetic case.

6. The magnetic apparatus of claim 1, wherein the non-ferromagnetic case comprises a pair of apertures adjacent the posterior side, the fastening strap being slidably received through the pair of apertures.

7. The magnetic apparatus of claim 1, wherein the hook portion is adjacent the first end of the fastening strap and has a length that is about one-fifth to about one-third the length of the loop portion.

8. The magnetic apparatus of claim 1, wherein the hook portion is adjacent the first end of the fastening strap and has a length in a range of about 3 to about 5 inches, and the loop portion is adjacent the second end of the fastening strap and has a length in a range of about 12 to about 15 inches.

9. The magnetic apparatus of claim 1, wherein the loop portion is adjacent the first end of the fastening strap and has a length that is about one-fifth to about one-third the length of the hook portion.

10. The magnetic apparatus of claim 1, wherein the loop portion is adjacent the first end of the fastening strap and has a length in a range of about 3 to about 5 inches, and the hook portion is adjacent the second end of the fastening strap and has a length in a range of about 12 to about 15 inches.

11. The magnetic apparatus of claim 1, wherein the posterior surface of the fastening strap includes an elastomeric material.

12. A method for attaching an object to a ferromagnetic structure comprising:
providing the magnetic apparatus of claim 1;
securing the fastening strap around the object by wrapping the fastening strap around the object's circumference with the posterior surface toward the object;
inserting the first end of the strap through the ring;
tightening the fastening strap by pulling the first end back on the fastening strap;
securing the fastening strap by pressing the hook and loop portions together; and
using the magnet to attach the object to the ferromagnetic structure.

13. A bottle for attaching to a ferromagnetic structure, comprising:
a body having a bottom surface and a sidewall, wherein the sidewall has a flattened sidewall surface and an upper sidewall portion that is angled with respect to the flattened sidewall portion, wherein the flattened sidewall surface has a cavity formed therein adjacent where the angled upper sidewall portion intersects with the flattened sidewall surface; and
a magnet housed in the cavity.

14. The bottle of claim 13, wherein the upper sidewall portion forms an angle in a range of about 15 to about 25 degrees with respect to the flattened sidewall surface.

15. The bottle of claim 13, wherein the bottom surface is angled away from perpendicular with respect to the flattened sidewall surface.

16. The bottle of claim 15, wherein the bottom surface forms an angle in a range of about 5 to about 15 degrees from perpendicular with the flattened sidewall surface.

17. The bottle of claim 13, wherein the flattened sidewall surface includes an elastomeric material.
